(19) United States
(12) Patent Application Publication
(10) Pub. No.: US 2008/0217356 A1
(43) Pub. Date: Sep. 11, 2008

(54) Dispensing Apparatus Including A Ceramic Body

(76) Inventors: Timothy D. Strecker, Corvallis, OR (US); Scott Breidenthal, Oceanside, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/126,817

(22) Filed: May 23, 2008

Related U.S. Application Data
(63) Continuation of application No. 10/765,628, filed on Jan. 27, 2004, now abandoned.

(51) Int. Cl. G01F 11/00; B67D 5/60; B67D 5/62; G01F 11/20; B23P 19/00

(52) U.S. Cl. 222/1; 222/145.6; 29/700; 222/146.5; 222/413

(57) ABSTRACT

A dispensing apparatus includes a ceramic body having a chamber and at least one inlet channel fluidically coupled to the chamber. The chamber has a first portion and an outlet portion. The dispensing apparatus also includes one or more feed screws having a helical thread disposed in the chamber. Rotation of the one or more feed screws urges a viscoelastic fluid in the chamber toward the outlet portion of the chamber.

### BACKGROUND

### Description of the Art

The ability to dispense a precise quantity of fluid such as an adhesive, a lubricant, an epoxy, a solder paste, or various other fluids at precise locations on a surface is important to a number of manufacturing processes, especially in the electronics, medical, automotive, and aerospace industries. The assembly of circuit boards, hard disk drives, inkjet cartridges, flat panel displays, cell phones, personal digital assistants, medical devices, sensors, motors, and pumps are just a few examples of manufactured products that utilize such processes.

For some applications, it is important both to achieve and to maintain high repeatability in the dispensing quantity in spite of variations in temperature, viscosity, or both. During normal operation, the liquid dispensed is sensitive to such changes, this is especially true where the dispensed liquid has a relatively high viscosity which itself varies as the temperature changes. This can result in changes in the volume of material dispensed over time. An example of this type of problem is in the encapsulation of integrated circuits where typically a two-part epoxy is premixed by the epoxy manufacturer and frozen. The premixed epoxy is then shipped and stored in this frozen state. When the buyer is ready to utilize the epoxy it must first be thawed and then used typically within an hour or two, and in some instances within several hours. Thus, during normal operation the viscosity may change, due to variations in the ambient temperature as well as due to the two components reacting creating a variation in the volume dispensed over time. For those dispensers that utilize pneumatically actuated time and pressure dispensing mechanisms these variations in fluid volume may be difficult to control.

In addition, there are also problems relating to the entrapment of air within the liquid to be dispensed because small gas bubbles in the liquid compress, causing sputtering and inaccuracies in the volume of material dispensed. Another problem is the constant almost continuous use that these dispensers may experience when operated under typical conditions on a high volume assembly line. If the material being dispensed hardens or degrades then the valve has to be cleaned. This can be a difficult operation, sometimes requiring the dispensing system to be returned to the supplier for reconditioning. Such reconditioning, typically, results either in higher cost requiring additional systems to be maintained on hand, or else down time of the assembly line.

Current dispenser technology for adhesives that are packaged as two parts (i.e. resin and hardener for two part epoxies) typically utilize static mixing to blend the resin and hardener together and then dispense the mixture directly to the bond line (i.e. onto the surface desired). A static mixer consists of immovable blades in a short cylindrical tube that facilitates dispersive mixing of the two parts as they exit there respective reservoirs. This technology works well for dispense rates in the milliliter to liter per second range. For systems that use a static mixer, the control, typically, utilizes either a motor or pneumatic pressure to push the adhesive through the mixer. Due to the viscoelastic behavior of most adhesives, controlling the dispense rate and dispense end point when dispensing a bead may be difficult. Static mixers can deliver flow rates in the micro-liter per second range, but typically not with the same accuracy as a positive displacement type pump. Generally, the accurate dispensing of viscoelastic fluids is made even more difficult as the distance between the dispense tip and fluid-driving mechanism is increased, such as by utilizing a longer static mixing tube. Even with small static mixer tubes, the lack of proximity of the dispense tip from the fluid-driving mechanism, typically, results in dispense start delays and dripping or oozing at the dispensing end point. As the dispense volumes diminish into the sub-milliliter range these issues become even more critical.

For dispense rates in the micro-liter per second range typically used in electronic, medical, and semiconductor manufacturing, the accuracy of the amount of material dispensed is achieved utilizing positive displacement dispenser technology. However, currently the ability to utilize positive displacement pump technology for adhesives that are packaged as two parts, generally requires the addition of a static mixer to blend the resin and hardener together. The feed screws or pistons of the positive displacement pump then dispense the mixed resin and hardener. An alternative technique, typically used in the industry, is to utilize pre-mixed, degassed, frozen materials such as epoxies that are thawed and dispensed utilizing positive displacement pump technology.

If these problems persist, the continued growth and advancements in the dispensing of a precise quantity of a liquid at precise locations on a surface, which is important in a number of manufacturing processes, will be hindered. In areas like consumer electronics, the demand for cheaper, smaller, more reliable, higher performance devices constantly puts pressure on improving and developing cheaper, faster and more reliable manufacturing processes such as the dispensing of fluids. The ability to optimize the dispensing of materials such as adhesives, lubricants, epoxies, and solder pastes will open up a wide variety of applications that are currently either impractical or are not cost effective.

### BRIEF DESCRIPTION OF THE DRAWINGS

FIG. 1 is a plan view with a partial cross-sectional view of a dispensing apparatus according to an embodiment of the present invention.

FIG. 2a is a perspective view of a dispensing apparatus including a removable insert and an open housing according to an alternate embodiment of the present invention.

FIG. 2b is a perspective view of the dispensing apparatus, shown in FIG. 2a, showing the removable insert placed within the open housing according to an alternate embodiment of the present invention.

FIG. 2c is a perspective view of the dispensing apparatus, shown in FIG. 2b showing the removable insert within the closed housing according to an alternate embodiment of the present invention.

FIG. 2d is an exploded cross-sectional view of a removable insert including a feed screw of the dispensing apparatus shown in FIGS. 2a -2c, according to an alternate embodiment of the present invention.

FIG. 3 is a cross-sectional view of a removable insert of a dispensing apparatus according to an alternate embodiment of the present invention.

FIG. 4 is a cross-sectional view of a chamber and inlet channels of a removable insert of a dispensing apparatus according to an alternate embodiment of the present invention.

FIG. 5 is a cross-sectional view of a chamber and inlet channels of a removable insert of a dispensing apparatus according to an alternate embodiment of the present invention.

FIG. 6a is a cross-sectional view of a chamber of a removable insert according to an alternate embodiment of the present invention.

FIG. 6b is a cross-sectional view 6b-6b showing the chamber shown in FIG. 6a along with two feed screws disposed within the chamber according to an alternate embodiment of the present invention.

FIG. 6c is an expanded cross-sectional view of one of the feed screws and the chamber wall shown in FIG. 6b according to an alternate embodiment of the present invention.

FIG. 7a is a cross-sectional view of a chamber of a removable insert according to an alternate embodiment of the present invention.

FIG. 7b is a cross-sectional view 7b-7b showing the chamber shown in FIG. 7a along with two feed screws disposed within the chamber according to an alternate embodiment of the present invention.

FIG. 8a is a cross-sectional view of a dispensing apparatus including heating elements according to an alternate embodiment of the present invention.

FIG. 8b is a cross-sectional view of a dispensing apparatus including a heating element according to an alternate embodiment of the present invention.

### DESCRIPTION OF THE PREFERRED EMBODIMENTS

The present invention advantageously utilizes a ceramic or cermet body including a ceramic or cermet feed screw, as part of a dispensing apparatus, to dispense quantities of a viscoelastic fluid of a precise volume. Examples of various viscoelastic fluids that may be dispensed utilizing such an apparatus include adhesives, lubricants, epoxies, underfill materials, solder pastes or other materials that generally have a viscosity of the order of 5,000 to 2,000,000 Centipoise. The dispensing apparatus of the present invention may accurately dispense viscoelastic materials as isolated structures commonly referred to as dots of the order of 0.2 to 25 mm in diameter with a height of the order of 0.2 to 2.0 mm. The dispensing apparatus also may accurately dispense a bead of fluid product of the order of 0.2 to 4 mm in width and 0.2 to 4.0 mm in height at rates of the order of 5.0 micro-liters per second to 100 micro-liters per second. In addition, the ability to rapidly and easily replace and clean those portions of the removable ceramic insert and feed screw, which come into contact with the dispensing fluid is advantageous. Even larger volumes may be dispensed by increasing the diameter of the chamber and feed screw.

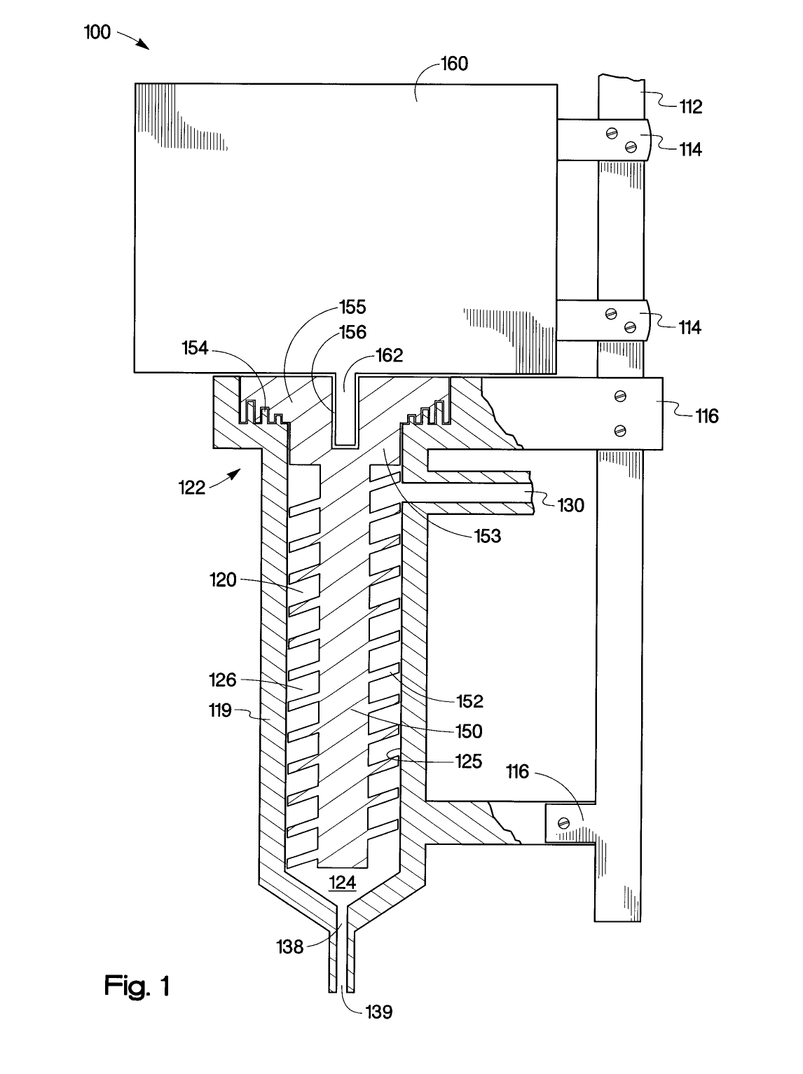

An embodiment of dispensing apparatus 100 of the present invention is shown, in a partially cross-sectional view, in FIG. 1. In this embodiment, dispensing apparatus 100 includes drive mechanism 160 rotationally coupled to feed screw 150 through drive shaft 162. Feed screw 150, includes helical threads 152 in sliding contact with sidewall 125 of chamber 120 formed in ceramic body 119. The particular gap utilized, between helical threads 152 and sidewall 125, will depend on various parameters such as the viscosity of the fluid being dispensed, the structure being dispensed, and the desired repeatability of the size of the dispensed structure. Helical threads 152 extend over a substantial portion of the length of feed screw 150 beginning near feed screw shank 153 and continuing to the opposite end of feed screw 150. In this embodiment, helical threads 152 have a right handed constant linear helical pitch. In alternate embodiments, feed screws having a left handed helical pitch also may be utilized. In addition, feed screws having either a right or left handed decreasing pitch also may be utilized. It should be appreciated that kneading threads, reverse threads, variable pitch threads, or cylindrical sections with no threads may be utilized in various combinations as well as numerous other thread designs.

Ceramic body 119 also includes inlet channel 130 through which a viscoelastic fluid is introduced into chamber 120. As feed screw 150 rotates helical threads 152 force the viscoelastic fluid captured between the threads and sidewall 125 of chamber 120 to compress and move in the direction of outlet region 124. Viscoelastic fluid that is urged by feed screw 150 into outlet region is urged or forced into outlet channel 138 and subsequently dispensed through dispensing tip or needle 139. By controlling the amount of rotation of feed screw 150 the rate of feed and subsequent volume of liquid product dispensed is controlled. In addition, helical threads 152 disposed between inlet channel 130 and first portion or drive portion 122 of chamber 120 hinders the viscoelastic fluid in chamber 120 from moving toward rotary seal 154. Inlet channel 130 is in fluid communication with a reservoir (not shown) that contains the viscoelastic fluid to be dispensed. In this embodiment, chamber 120 includes drive portion 122 disposed proximate to drive mechanism 160, outlet region or portion 124 fluidically coupled to outlet channel 138 that forms a portion of dispensing tip 139, and middle portion 126 disposed between first portion 122 and outlet portion 124.

Drive shaft socket 156 is formed coaxially in drive coupling end 155 of feed screw 150. Drive shaft socket 156, in this embodiment, has a square cross-section sized to mate with drive shaft 162 that also has a square cross-section. However, in alternate embodiments, the drive shaft and the shaft socket may have other shapes such as rectangular, hexagonal, or a cylindrical shaft with a flat face forming a D cross sectional shape. In alternate embodiments other rotational coupling mechanisms also may be utilized. For example, drive shaft 162 may include a socket that receives a shaft formed on feed screw 150. In one embodiment, a flexible rotary coupling may be utilized to couple drive shaft 162 to feed screw 150. In still other embodiments, other coupling mechanisms such as a screw coupling or keyed coupling also may be utilized. In addition feed screw 150 also forms rotary seal 154 between the feed screw and chamber 120. In this embodiment, rotary seal 154 is, what is commonly referred to as, a labyrinth seal formed by a series of mating concentric grooves formed in both the feed screw and the chamber as shown in the partial cross-sectional view in FIG. 1. The labyrinth seal hinders the viscoelastic fluid contained in chamber 120 from moving out of chamber 120 and coming in contact with other surfaces such as the rotary mechanism or mounting brackets. Feed screw 150, in this embodiment also includes feed screw shank 153 that is in sliding contact with sidewall 125 of chamber 120 providing further hindrance of fluid moving out of chamber 120 toward drive portion 122. In alternate embodiments, other various types of rotary seals such as O-rings, cup seals, spring-loaded cup seals, discs, or bushings, also may be utilized. For example, feed screw shank 153 may include a series of parallel grooves encircling the shank with an O-ring positioned in or against each groove forming a seal between the shank and sidewall 125 of chamber 120. Another example is utilizing one or more ferro-fluidic seals.

In this embodiment, ceramic body 119 and feed screw 150 are formed utilizing high purity aluminum oxide in the range from about 96% purity to about 99% purity. For purposes of the present invention the term ceramic may include various ceramic or refractory materials as well as mixtures and alloys of ceramic materials including cermets. Thus, in alternate embodiments other materials such as various oxides, nitrides, carbides, and borides also may be utilized; examples include sapphire, graphite, glass, silicon carbide, boron nitride, zirconia, garnet, tungsten carbide, titanium nitride, molybdenum boride as well as mixtures of various materials. In still other embodiments various cermets such as titanium carbide and nickel also may be utilized. In addition, ceramic body 119 may be formed utilizing one material such as aluminum oxide, and feed screw 150 may be formed utilizing a different material such as titanium carbide and nickel. Both ceramic body 119 and feed screw 150 may be cleaned utilizing a high temperature bake process in an air, an oxygen, or an ozone ambient to volatilize hardened viscoelastic fluid remaining from use, organic residues and organic contaminants. For example, ceramic body 119 or feed screw 150 or both may be heated above 400° C. in any of the above environments to remove or volatilize organic material that remains on the parts after use. The particular temperature utilized will depend on various factors such as the amount of material to be removed, the chemical and thermal properties of the material to be removed, as well as the desired cycle time to clean the parts. Depending on the desired cycle time, temperatures generally will be in excess of 300° C. with temperatures above 450° C. providing even more rapid cleaning. In addition, both the feed-screw and ceramic body may also be cleaned utilizing various combinations of high temperature treatment and reactive plasma treatments. Further, strong acids, bases, and solvents that would damage plastic and metal parts also may be utilized to clean either the feed screw, ceramic body or both.

Ceramic body 119, in this embodiment, also includes body-mounting brackets 116 that mount to dispensing apparatus supporting rod 112. In addition drive mechanism also includes drive-mounting brackets 114 that mount to dispensing apparatus supporting rod 112. In this embodiment, both the body and drive mounting brackets are attached to the supporting rod utilizing screws, however it should be appreciated that numerous other fastening techniques and numerous other mounting structures also may be utilized. For example, the drive mechanism and ceramic body may be attached to the supporting rod utilizing clamps including quick release type clamps that would make attachment and detachment of the ceramic body to the drive mechanism easier.

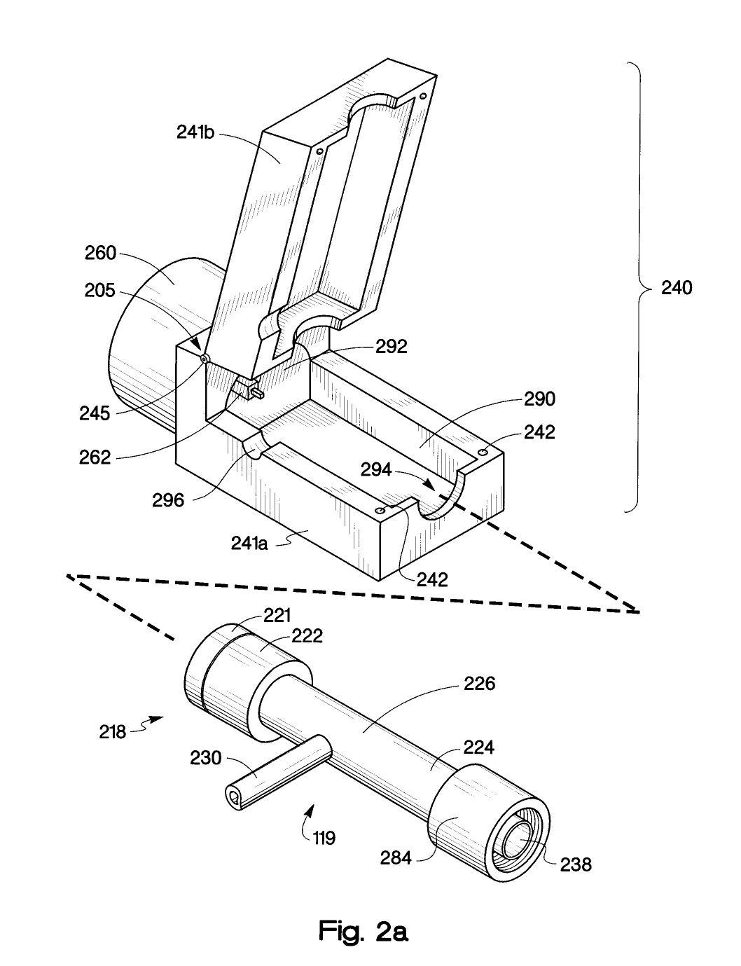

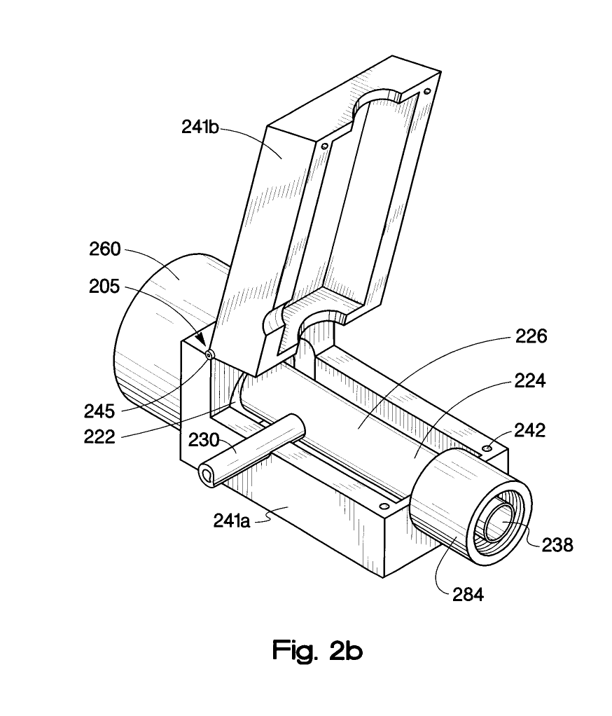

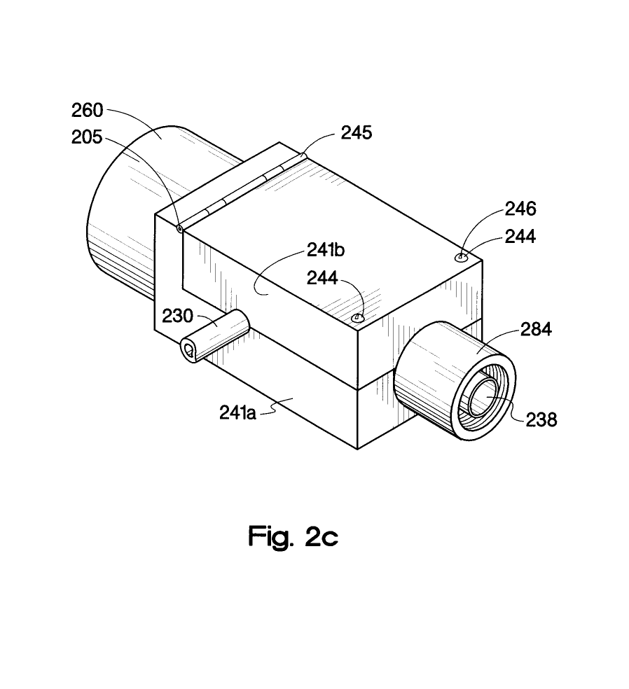

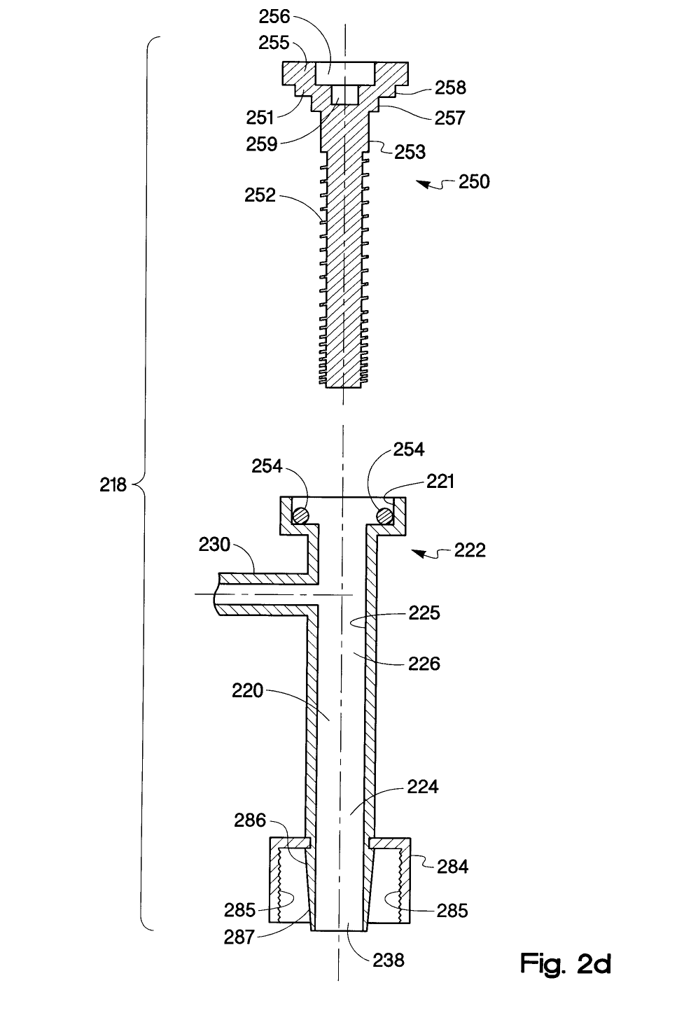

An alternate embodiment of a dispensing apparatus, of the present invention, is shown, in a perspective view, in FIG. 2a, where removable ceramic insert 218 is received in housing 240 that includes main body portion 241a and front body portion 241b. Front body portion 241b is attached to main body portion 241a at pivot point 205 through hinge 245 so that front body portion 241b pivots away from main body portion 241a when locking mechanism 246 (see FIG. 2c) is released. It is understood that other mechanisms also may be utilized to secure the two housing portions together while allowing the housing to be separated or opened to allow removal of removable ceramic insert 218. Main body portion 241a also includes threaded openings 242 that are adapted to receive captive screws 244 as shown in FIG. 2c. Main body portion 241a and front body portion 241b cooperate to form main cavity 290, drive cavity 292, outlet cavity 294, and input cavity 296. In this embodiment, all of these cavities are formed as one half openings in each of main body portion 241a and front body portion 241b for ease of manufacturing and assembly as shown in FIGS. 2a -2c. However, in alternate embodiments, these cavities need not be each formed as one half in either main body portion 241a or front body portion 241b as both the shape and the amount of the cavity formed in either body portion may be varied. For example, in one embodiment, main cavity 290 may be formed substantially within main body portion 241a and front body portion 241b formed as essentially a cover for housing 240. In another example, the cavity may be formed in a conformal shape to that of removable ceramic insert 218.

Removable ceramic insert 218 is insertable into main cavity 290 of housing 240 as shown in FIG. 2b. Inlet channel 230 fits within input cavity 296 (see FIG. 2a) formed in housing 240 and extends outside of housing 240 to fluidically couple to a fluid reservoir (not shown). Inlet channel 230, in this embodiment, extends radially from middle portion 226 of removable ceramic insert 218. In alternate embodiments, the fluidic coupling to a fluid reservoir may be provided within housing 240 obviating the need for inlet channel 230 to extend out the side of housing 240. Outlet portion 224 closest to outlet cap 284 of removable ceramic insert 218 fits within outlet cavity 294 (see FIG. 2a) allowing outlet cap 284 to extend beyond housing 240 providing for convenient attachment and detachment of a dispenser tip (not shown). Drive shaft 262 of drive mechanism 260 is shown, in FIG. 2a extending into drive cavity 292. Drive cavity 292 is sized to receive either feed screw 250 and first portion 222 or removable ceramic insert 218. In this embodiment, drive mechanism 260 may be either a servomotor or stepper motor that provides accurate control of the amount of rotation of feed screw 250. In alternate embodiments other drive mechanisms using tachometers or rotary encoders also may be utilized.

Removable ceramic insert 218 is shown in FIG. 2b inserted into housing 240 with front body portion 241b in an open position. Feed screw 250 engages drive shaft 262 in drive cavity 292 of housing 240. FIG. 2c shows front body portion 241b with locking mechanism 246 in a locked position. As shown in FIG. 2c locking mechanism 246 consists of captive screws 244 that are threaded into threaded openings 242 shown in FIG. 2a. Those of ordinary skill in the art will readily recognize that there are numerous other locking mechanisms that may be utilized such as a latch, spring clamp or spring loaded bayonet mechanism.

An exploded cross-sectional view of removable ceramic insert 218, including feed screw 250 that slidably fits in ceramic body 219, is shown in FIG. 2d. First and second drive shaft sockets 256 and 259 are formed coaxially in drive coupling end 255 of feed screw 250. First and second drive shaft sockets 256 and 259 each have a square cross-section sized to mate with the two square portions of drive shaft 262 of rotary mechanism 260 shown in FIG. 2a. However, in alternate embodiments, the drive shaft and the shaft socket or sockets may have other shapes such as rectangular, hexagonal, or a cylindrical shaft with a flat face forming a D cross sectional shape. In alternate embodiments other rotational coupling mechanisms also may be utilized. For example, drive shaft 262 may include a socket that receives a drive shaft formed on feed screw 250. In one embodiment, a flexible rotary coupling may be utilized to couple drive shaft 262 to feed screw 250. In still other embodiments, other coupling mechanisms such as a screw coupling or keyed coupling also may be utilized.

Feed screw 250 includes first annular shoulder 257 that has a diameter greater than the diameter of feed screw shank 253 and less than the diameter of second annular shoulder 258. In this embodiment, the particular diameter of annular shoulder 257 depends on the particular size of the elastomeric O-ring utilized to form seal 254. When feed screw 250 is inserted into chamber 220 an annular cavity is formed by face 251, first annular shoulder 257, and internal wall 221 of first portion 222 of chamber 220. Face 251 compresses rotary seal 254, while the outer surface of first annular shoulder 257 forms an inner sealing surface, and a portion of internal wall 221 forms an outer sealing surface, hindering fluid introduced into chamber 220 via inlet channel 230 from moving into first portion 222 of chamber 220. In alternate embodiments, other various types of rotary seals also may be utilized. For example, feed screw shank 253 may include a series of parallel grooves encircling the shank with an O-ring positioned in or against each groove forming a seal between the shank and sidewall 225 of chamber 220. Another example is utilizing one or more ferro-fluidic seals. Second annular shoulder 258 has a diameter less than the diameter of the opening formed by internal wall 221.

Feed screw 250 also includes feed screw shank 253 and helical threads 252 that are in sliding contact with sidewall 225 of chamber 220. Generally, the gap between either feed screw shank 253 or helical threads 252 and sidewall 225 is in the range from about 0.0001 inches to about 0.002 inches. The particular gap utilized will depend on various parameters such as the viscosity of the fluid being dispensed, the structure being dispensed, and the desired repeatability of the size of the dispensed structure. Helical threads 252 extend over a substantial portion of the length of feed screw 250 beginning near feed screw shank 253 and continuing to the opposite end of feed screw 250. In this embodiment, helical threads 252 have a right-handed helical pitch that decreases as the threads approach second portion 224. In alternate embodiments, feed screws having a left handed helical pitch also may be utilized. In addition, feed screws having either a right or left handed linear pitch also may be utilized. It should be appreciated that kneading threads, reverse threads, variable pitch thread, cylindrical sections with no threads all may be utilized in various combinations as well as numerous other thread designs. Feed screw 250 is rotated by drive mechanism 260 shown in FIG. 2a. As feed screw 250 is rotated helical threads 252 force a viscoelastic fluid captured between helical threads 252 and sidewall 225 of chamber 220 to compress and move in the direction of outlet portion 224 of chamber 230. The accurate control of the amount rotation of feed screw 250 provides a precise control of the rate of feed and subsequent volume of fluid product dispensed. As viscoelastic fluid product is dispensed an additional supply of fluid is provided through inlet channel 230. In addition, outlet portion 224 of chamber 220 includes outlet cap 284 that extends beyond outlet cavity 294 (see FIG. 2a), to output channel 238. Threads 285 are formed on the inner surface of outlet cap 284. Upper portion 286, that is closer to outlet cap 284, is greater in diameter than lower portion 287 forming a tapered shoulder utilized to mount a removable dispenser tip (not shown). Those skilled in the art will readily appreciate that other mounting arrangements may be utilized.

In this embodiment, ceramic body 219 and feed screw 250 are formed utilizing high purity aluminum oxide in the range from about 96% purity to about 99% purity. For purposes of the present invention the term ceramic may include various ceramic or refractory materials as well as mixtures and alloys of ceramic materials including cermets. Thus, in alternate embodiments other materials such as various oxides, nitrides, carbides, and borides also may be utilized; examples include sapphire, graphite, glass, silicon carbide, boron nitride, zirconia, garnet, tungsten carbide, titanium nitride, molybdenum boride as well as mixtures of various materials. In still other embodiments various cermets such as titanium carbide and nickel also may be utilized. In addition, ceramic body 219 may be formed utilizing one material such as aluminum oxide, and feed screw 250 may be formed utilizing a different material such as titanium carbide and nickel.

An alternate embodiment, of the present invention, is shown, in a cross-sectional view, in FIG. 3, where dispensing apparatus 300 mixes two different fluid components to form a viscoelastic fluid product; and accurately dispenses a pre-selected amount of the viscoelastic fluid product utilizing feed screw 350 to both mix and dispense the viscoelastic fluid product. In this embodiment, first and second inlet channels 330 and 334 are in fluid communication with chamber 320 via first and second inlet ends 331 and 335 respectively. A first component fluid in a reservoir (not shown) is fed or delivered through first inlet channel 330 via first inlet end 331 to chamber 320 of ceramic body 319. A second component fluid in a second reservoir (not shown) is fed or delivered through second inlet channel 334 via second inlet end 335 to chamber 320. As shown in FIG. 3 second inlet end 335 of second inlet channel 334 opens into chamber 320 at a point closer to first portion 322 of ceramic body 319 than first inlet end 331 of first inlet channel 330. First inlet end 331 and second inlet end 335 are separated in a direction along the axis of the chamber that precludes interaction of first and second component fluids in either inlet channels 330 and 334.

In this embodiment, a portion of chamber 320 and a portion of feed screw 350 have a conical or tapered shape with helical threads 352 having a linear pitch. As described in the embodiment shown in FIG. 2, feed screw 350 may include sections with various configurations of helical threads. When feed screw 350 is rotated helical threads 352 are in sliding contact with side wall 325 of chamber 320. The clearance or gap between helical threads 352 and sidewall 325 may be adjusted and is generally in the range from about 0.0001 inches to about 0.0008 inches. In alternate embodiments the clearance or gap may be in the range from about 0.0001 inches to about 0.002 inches. As first and second fluid components are fed into chamber 320 at first and second inlet ends 331 and 335 the reduction in area created by the smaller diameter of the tapered shape feed screw 350 and chamber 320 produces a reduction in volume leading to an increase in pressure as the fluid is moved toward outlet portion 324 of chamber 320, similar to that obtained with feed screw 150 utilizing a variable pitch with straight parallel sidewalls. In this embodiment, rotary seal 354 is a cup seal, however, an O-ring seal or other sealing mechanisms also may be utilized in alternate embodiments.

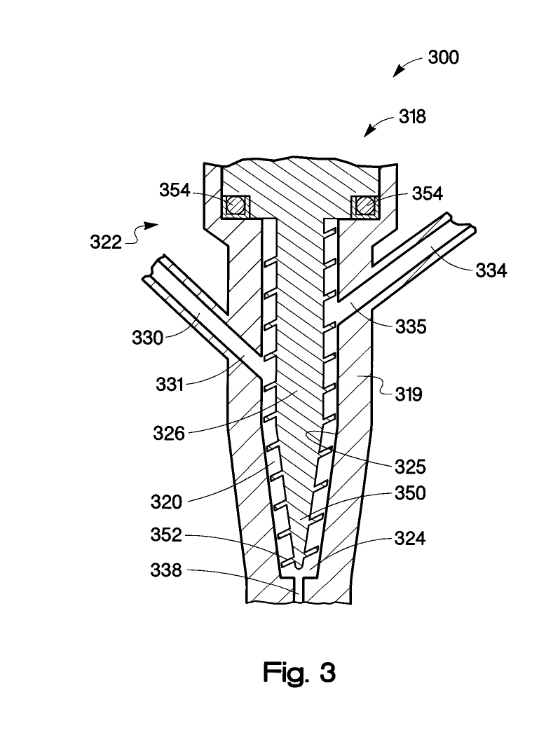

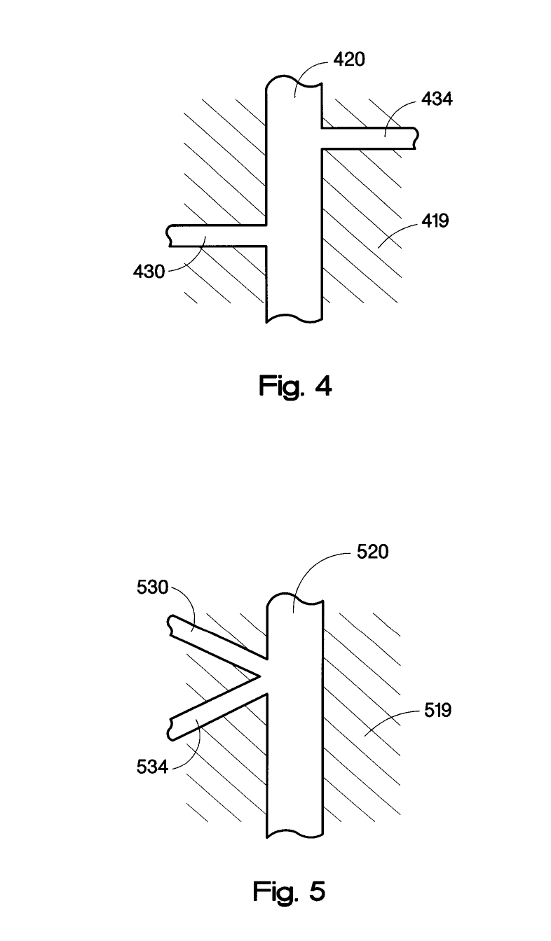

An alternate embodiment of the present invention, where first and second inlet channels 430, 434 extend radially from chamber 420 formed in ceramic body 419, is shown, in a cross-sectional view, in FIG. 4. First and second inlet channels 430, 434 are separated in a direction along the axis of chamber 420 to preclude the interaction of a first and a second component fluid from either inlet channel as first and second component liquids are fed into chamber 420 from first and second reservoirs (not shown).

An alternate embodiment of the present invention, where first and second inlet channels 530, 534 are attached to chamber 520 at a common location, is shown, in a cross-sectional view, in FIG. 5. The angle formed between the axes of inlet channels 530, 534 is acute as shown in FIG. 5. In this embodiment, the angle is less than ninety degrees; however, in alternate embodiments an angle less than one hundred eighty degrees also may be utilized depending on both the feed rates and pressure differential utilized to feed the first and second component fluids to chamber 520 formed in ceramic body 519. This embodiment is advantageous in alleviating back flow problems for those applications that utilize a significant feed rate differential between the first and second component fluids.

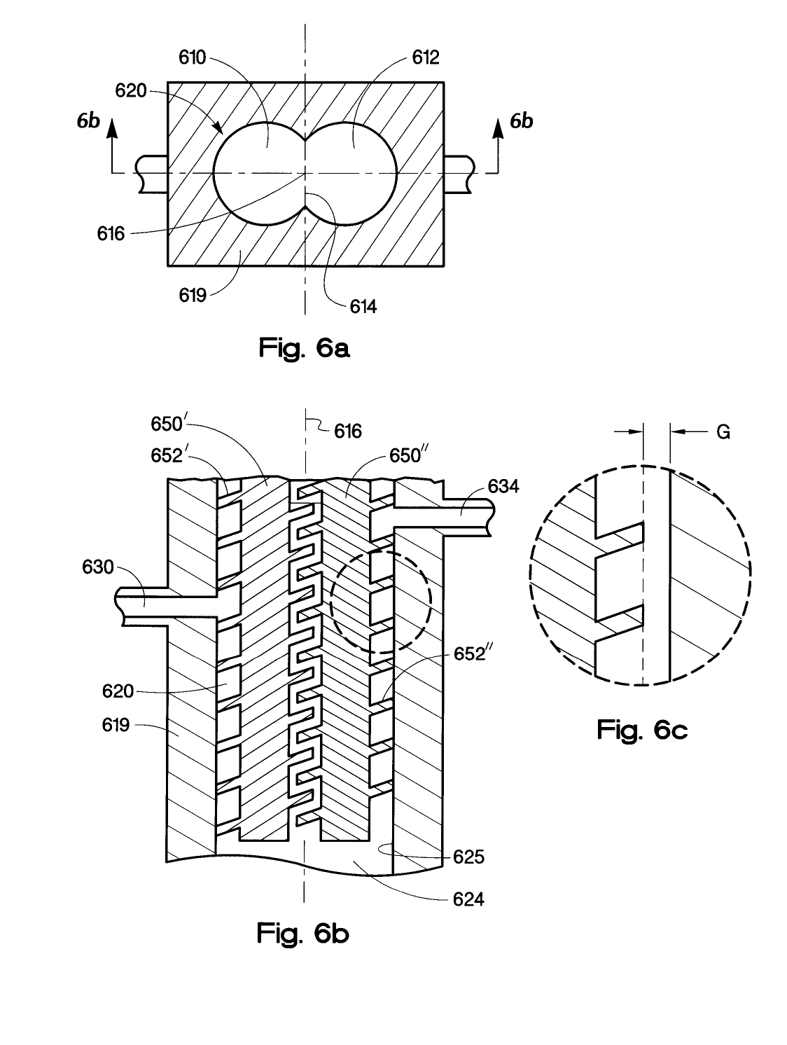

An alternate embodiment of the present invention is shown, where two feed screws 650′ and 650″ are located within chamber 620 in FIGS. 6a-6c. FIG. 6a shows a cross-sectional view, cut perpendicular to chamber axis 616, of chamber 620 located in ceramic body 619. In this embodiment, chamber 620 includes two circular bores 610 and 612 formed in ceramic body 619 that have parallel axes and extend centrally and longitudinally through ceramic body 619. Circular bores 610 and 612 communicate with each other along common chord 614. Feed screws 650′ and 650″ are rotatably supported within circular bores 610 and 612 of chamber 620 and are in sliding contact with sidewall 625 as shown in FIG. 6b, in a cross-sectional view cutting chamber 620 longitudinally. In this embodiment, the gap G between helical threads 652′, 652″ and side wall 625 is of the order of 0.0001 to 0.0008 inches, but may be smaller or larger depending on the particular application, as shown in the expanded view in FIG. 6c. Helical threads 652′ and 652″, in this embodiment, are partly overlapping along chord 614. Similar to previously described embodiments, the first and second component fluids, are introduced into chamber 620 via first and second inlet channels 630 and 634. As feed screws 650′, 650″ rotate helical threads 652′, 652″ engage each other in a meshing manner, as shown in FIG. 6b, causing the first and second component fluids in the turns of helical threads 652′ and 652″ to move in an axial direction resulting in both mixing of the first and second component fluids to form a fluid product as well as dispensing of fluid product. The intermeshing of the helical threads 652′ and 652″ provides a volumetric transport of material. Feed screws 650′ and 650″ can run in two modes: co-rotating and counter-rotating depending on screw design where typically co-rotating feed screws can be operated at higher speeds. As described in previous embodiments, alternate embodiments may utilize left handed threads instead of the right handed pitch of feed screws 650′ and 650″ illustrated in FIGS. 6a-6c.

The incorporation of two feed screws 650′ and 650″ in chamber 620 provides a dispenser which may dispense both, a wider range of viscosities, in particular for materials at the low end of the viscosity range, as well as fluids containing a large particle size variation. In addition, two feed screws provide a greater degree of mixing than a single feed screw because the fluidic dynamics are much more complex. Thread configurations are also more flexible utilizing two feed screws. Further, when they are intermeshing, two feed screws are typically self-wiping (i.e. self cleaning). Finally, feed screws 650′ and 650″ may include sections with various configurations of helical threads as described in previous embodiments.

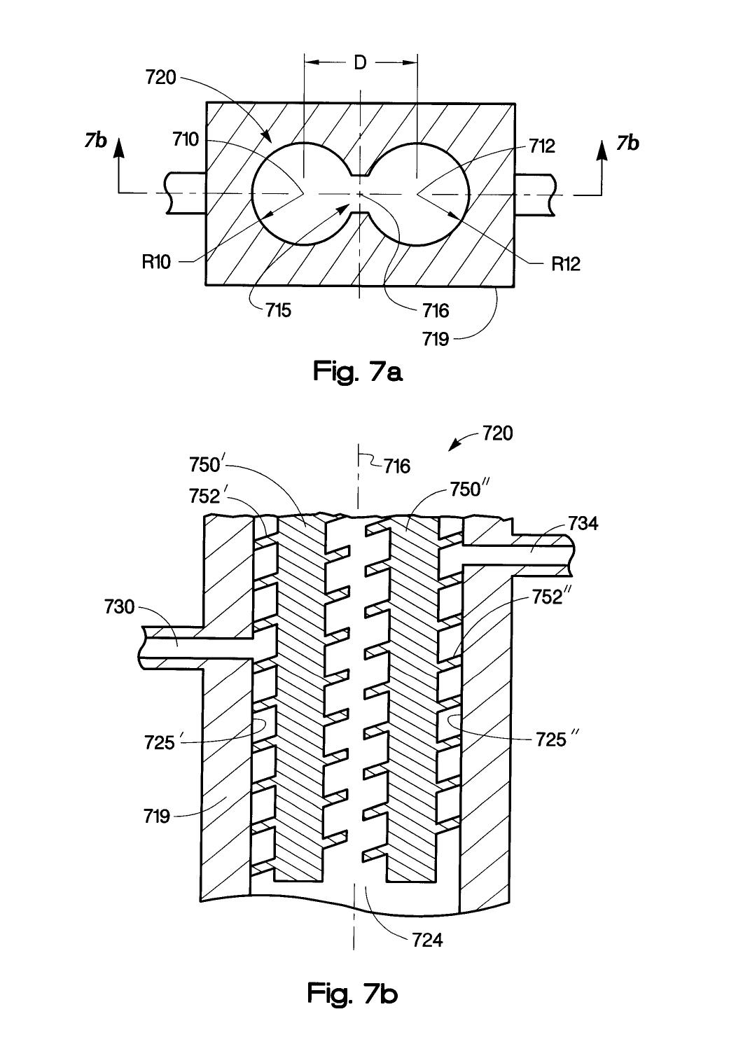

An alternate embodiment of the present invention is shown in FIGS. 7a-7b, where two feed screws 750′ and 750″ are located within chamber 720 that includes two non-overlapping cylindrical bores. FIG. 7a shows a cross-sectional view, cut perpendicular to chamber axis 716, of chamber 720 located in ceramic body 719. In this embodiment, chamber 720 includes two circular bores 710 and 712, having radius R10 and R12 respectively, formed in ceramic body 719 which have parallel axes and extend centrally and longitudinally through ceramic body 719. The distance D between the axis of circular bore 710 and the axis of circular bore 712 is greater than or equal to the sum of R10 and R12. Circular bores 710 and 712 communicate with each other through common opening 715. Feed screws 750′ and 750″ are rotatably supported within circular bores 710 and 712 of chamber 720 as shown in FIG. 7b, in a cross-sectional view cutting chamber 720 longitudinally. Helical threads 752′ are in sliding contact with sidewall 725′ of bore 710 and helical threads 752″ are in sliding contact with sidewall 712. Similar to previously described embodiments, first inlet channel 730 introduces the first component fluid into bore 710 and second inlet channel 734 introduces the second component fluid into bore 712. Helical threads 752′ and 752″, in this embodiment, are non-overlapping. As feed screws 750′ and 750″ are rotated helical threads 752′ and 752″ cause the first and second component fluids in the turns of helical threads 752′ and 752″ to move in an axial direction causing both mixing of the first and second component fluids to mix and form a fluid product as well as the dispensing of fluid product as shown in FIG. 7b. Feed screws 750′ and 750″ can run in two modes: co-rotating and counter-rotating depending on screw design. In addition, feed screws 750′ and 750″ may include sections with various configurations of helical threads as described in previous embodiments.

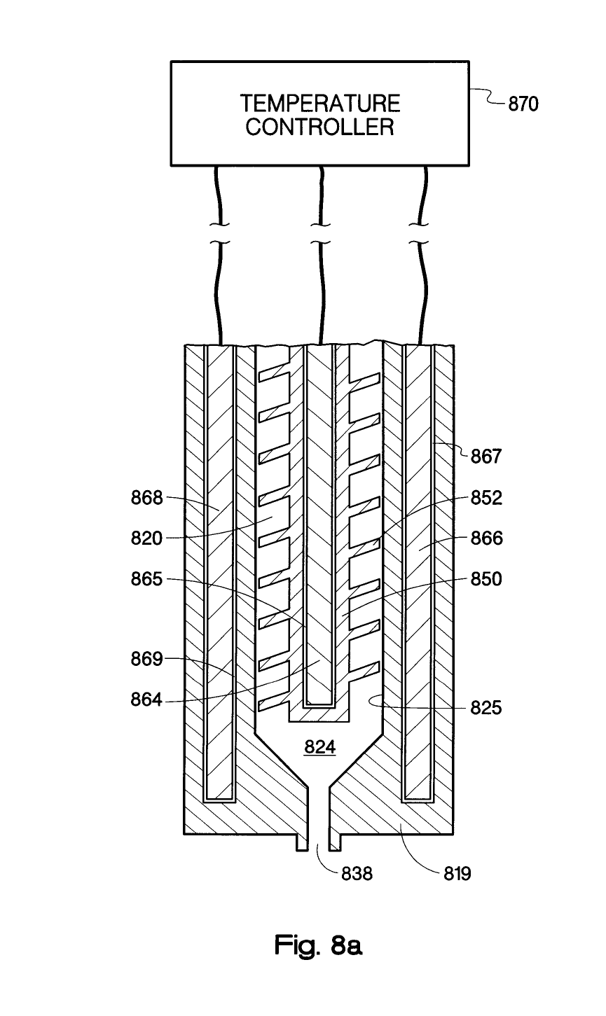

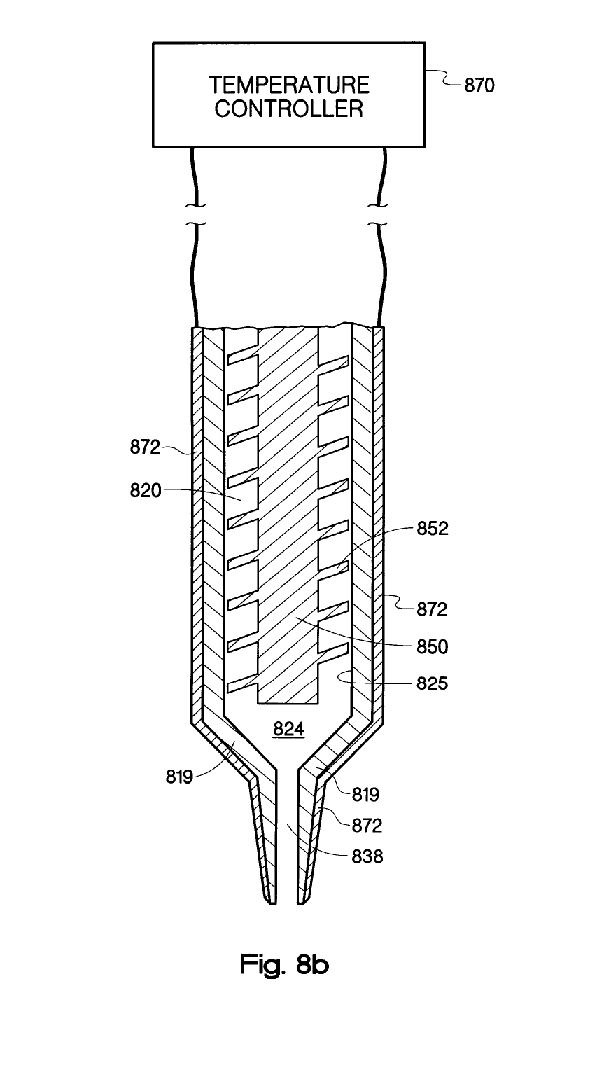

An alternate embodiment of the present invention is shown, in a cross-sectional view, in FIG. 8a, where feed screw 850 may be heated by feed screw heater 864 and ceramic body 819 may be heated by body heaters 866, and 868. Feed screw heater 864 and body heaters 866 and 868 are electrically coupled to temperature controller 870 to control the temperature of feed screw 850 and ceramic body 819. Feed screw heater 864 fits within feed screw heater cavity 865 formed in feed screw 850. In this embodiment, body heaters 866 and 868 are disposed within body heater cavities 867 and 869 formed in ceramic body 819. However, in alternate embodiments, body heaters 866 and 868 may be disposed within a housing similar to that shown in FIGS. 2a-2c with the body heaters either proximate to or in thermal contact with the ceramic body. In one embodiment, a body heater is formed utilizing a heating tape wrapped around the ceramic body. In addition, either body heaters 866 or 868 may be extended to provide more uniform heating of output channel 838 or additional heaters may be utilized depending on the particular application in which the dispensing apparatus will be utilized. Feed screw 850 includes linear helical threads 852 in sliding contact with sidewalls 825 of chamber 820; however, in alternate embodiments any of the previously described feed screws and helical threads also may be utilized in this embodiment. Feed screw heater 864, and body heaters 866 and 868 heat the viscoelastic fluid located within chamber 820 to a temperature in the range from about 30° C. to about 150° C. The particular temperature utilized will depend on various factors such as the temperature dependence of the viscosity of the viscoelastic fluid, the dispensing rate, and the repeatability and accuracy of the structure dispensed. Heating the viscoelastic fluid in chamber 820 provides for additional control of the viscosity of the fluid and in particular heating provides for the dispensing of highly viscous fluids that would be difficult to dispense without heating. In this embodiment feed screw heater 864 and body heaters 866 and 868 are formed from nichrome heating wire, however in alternate embodiments other heating techniques also may be utilized. For example, infrared heaters, hot gas or liquid may be utilized to heat either the feed screw heater or the body heaters or both.

An alternate embodiment of the present invention is shown, in a cross-sectional view, in FIG. 8b, where ceramic body 819 may be heated by ceramic body heater 872 formed on the outer surface of ceramic body 819. Ceramic body heater 872 is electrically coupled to temperature controller 870 to control the temperature of feed screw 850, ceramic body 819, and a viscoelastic fluid captured between helical threads 852 and sidewall 825 of chamber 820. In this embodiment, ceramic body heater 872 is a resistive heater formed utilizing conventional thick film processing techniques. In an alternate embodiment, ceramic body heater 872 is a thin film heater formed utilizing various deposition processes such as sputter deposition, evaporation, or electroplating. Utilization of a thick film or thin film heater disposed on the outer surface of ceramic body provides direct thermal coupling of the heater to the ceramic body utilizing less energy to heat the ceramic body and fluid within the chamber of the ceramic body. In this embodiment, ceramic body heater 872 is illustrated as a continuous layer on the outer surface of ceramic body 819. However, in alternate embodiments, other structures or patterns such as a spiral, a helical, or a stripe pattern or other structures such as patches, sections or particular portions of ceramic body may be covered either with a thick film heater utilizing various selective printing techniques such as silk screening or a thin film heater utilizing various lithographic or printed circuit masking techniques. Utilization of a heater to heat the fluid in the chamber substantially above room temperature may be utilized to substantially reduce the viscosity of the viscoelastic fluid to provide faster dispensing, more accurate dispensing, or dispensing of a highly viscous fluid that would not otherwise be desirable to dispense at a lower temperature or combinations thereof. Heating of the viscoelastic fluid in the chamber to just above room temperature provides for a small reduction in viscosity as well as providing for a more constant temperature by keeping the fluid at a temperature that exceeds the ambient temperature swings normally encountered during use in the particular environment in which the dispensing apparatus is used.

What is claimed is:

1. A dispensing apparatus, comprising:
a ceramic body having a chamber, said chamber including a first portion and an outlet portion, said ceramic body having:
a first inlet channel delivering a first component viscoelastic fluid to said chamber, and
a second inlet channel delivering a second component viscoelastic fluid to said chamber, said first and said second inlet channels disposed to hinder interaction between said first and said second component viscoelastic fluids in either inlet channel; and
at least one feed screw having a thread disposed in said chamber, wherein rotating said at least one feed screw mixes said viscoelastic fluid components to form a product and dispenses a pre-selected amount of said product from said chamber.

2. The dispensing apparatus in accordance with claim 1, wherein said first and second inlet channels extend radially from said chamber where one inlet channel is closer to said first portion of said chamber than said second inlet channel and said first and second inlet channels are separated by at least a distance sufficient to preclude interaction, in either inlet channel, of said first and second component viscoelastic fluids

3. The dispensing apparatus in accordance with claim 1, wherein said first inlet channel descends to said chamber and said second inlet channel ascends to said chamber, wherein said first and said second inlet channels attach to said chamber at a common location forming an acute angle between said first and said second inlet channels

4. The dispensing apparatus of claim 1, wherein the at least one feed screw further comprises two feed screws having threads and wherein said chamber further comprises a middle portion disposed between said first portion and said outlet portion, said middle portion having a barrel body including two cylindrical bores, each cylindrical bore having one of said two feed screws rotatably disposed therein.

5. The dispensing apparatus of claim 4, wherein said two cylindrical bores further comprise either two partly overlapping cylindrical bores or two non-overlapping cylindrical bores.

6. The dispensing apparatus of claim 5, wherein each of said two partly overlapping cylindrical bores further comprises an internal wall substantially parallel to the other, said threads of said two feed screws in sliding contact with said internal wall of said bore in which said feed screw is disposed; and said threads of said two feed screws are intermeshing in a region of overlap of said two partly overlapping cylindrical bores.

7. The dispensing apparatus of claim 5, wherein each of said two non-overlapping cylindrical bores further comprise an internal wall substantially parallel to the other, said threads of said two feed screws in sliding contact with said internal wall of said bore in which said feed screw is disposed; and said threads of said two feed screws are non-intermeshing.

8. The dispensing apparatus of claim 4, wherein said two feed screws further comprise helical threads having a variable pitch that decreases as said helical threads approach said outlet portion of said chamber.

9. The dispensing apparatus of claim 1, wherein the chamber further comprises a middle portion disposed between said first portion and said outlet portion, said middle portion having smoothly varying tapered internal walls, said middle portion having a first diameter near said first portion and a second diameter near said second portion; wherein said first diameter is greater than said second diameter; and wherein said threads of said at least one feed screw are in sliding contact with said tapered internal walls of said middle portion of said chamber.

10. The dispensing apparatus of claim 1, wherein said chamber further comprises a third portion having an internal wall with a cylindrical shape forming a substantially cylindrical internal volume, said cylindrical shape includes an axis extending centrally and longitudinally through said ceramic body, said at least one feed screw further comprises helical threads having a linear pitch; wherein said helical threads of said at least one feed screw are in sliding contact with said internal wall of said third portion of said chamber.

11. The dispensing apparatus of claim 1, wherein said ceramic body is disposed within an internal cavity of a housing, wherein said ceramic body is formed as a removable ceramic insert.

12. The dispensing apparatus of claim 11, further comprising at least one heater element disposed within said internal cavity of said housing.

13. The dispensing apparatus of claim 12, wherein said heater element is selected from the group consisting of an infrared heating element, a thick film heating element, a thin film heating element, a heating rod, and combinations thereof.

14. The dispensing apparatus of claim 12, further comprising a temperature controller electrically coupled to said at least one heater element, wherein said temperature controller maintains said ceramic body at a preselected temperature, said pre-selected temperature is in the range from about 30° C. to about 150° C.

15. The dispensing apparatus in accordance with claim 16, wherein said housing further comprises:
a main body, having a first portion of said internal cavity formed therein; and
a front body having a second portion of said internal cavity formed therein.

16. The dispensing apparatus in accordance with claim 23, wherein said housing further comprises:
a hinge mechanism, hingedly coupling said main body to said front body; and
a locking mechanism releasably securing said main body to said front body.

17. The dispensing apparatus of claim 1, further comprising at least one heater element formed on at least a portion of an outer surface of said chamber.

18. The dispensing apparatus of claim 17, wherein said at least one heater element is selected from the group consisting of an infrared heating element, a thick film heating element, a thin film heating element, and combinations thereof.

19. The dispensing apparatus of claim 17, further comprising a temperature controller electrically coupled to said at least one heater element, wherein said temperature controller maintains said ceramic body at a pre-selected temperature, wherein said pre-selected temperature is in the range from about 30° C. to about 200° C.

20. The dispensing apparatus of claim 1, wherein said ceramic body further comprises a heater cavity formed in said ceramic body, said heater cavity adapted to accept a heater rod.

21. The dispensing apparatus of claim 1, wherein said at least one feed screw further comprises a heater element formed therein.

22. The dispensing apparatus of claim 1, wherein said at least one feed screw is formed utilizing either a ceramic material or a cermet material.

23. The dispensing apparatus of claim 1, wherein said at least one feed screw further comprises a helical thread having a decreasing variable pitch moving from near said first portion towards said outlet portion.

24. The dispensing apparatus in accordance with claim 1, wherein said first and second inlet channels extend from said chamber where one inlet channel is closer to said first portion of said chamber than said second inlet channel and said first and second inlet channels are separated by a vertical distance sufficient to preclude interaction, in either inlet channel, of said first and second component viscoelastic fluids,
wherein the at least one feed screw further comprises two feed screws each having threads and each feed screw includes a heater element formed therein,
wherein said chamber further comprises a middle portion disposed between said first portion and said outlet portion, said middle portion having a barrel body including two cylindrical bores,
wherein each cylindrical bore having one of said two feed screws rotatably disposed therein,
wherein said two cylindrical bores further comprise either two partly overlapping cylindrical bores or two non-overlapping cylindrical bores
wherein said threads have a variable pitch portion that decreases as said threads approach said outlet portion of said chamber and have a linear pitch portion proximate to said first portion,
wherein said ceramic body is disposed within an internal cavity of a housing, said housing having:
a main body, having a first portion of said internal cavity formed therein;
at least one heater element, such as an infrared heating element, a thick film heating element, or a thin film heating element disposed within said internal cavity of said housing;
a front body having a second portion of said internal cavity formed therein;
a locking mechanism releasably securing said main body to said front body; and
a hinge mechanism, hingedly coupling said main body to said front body, wherein said ceramic body is formed as a removable ceramic insert, and said ceramic body includes a heater cavity formed in said ceramic body, said heater cavity adapted to accept a heater rod.

25. The dispensing apparatus of claim 1, wherein the at least one feed screw further comprises two feed screws each having threads, wherein each feed screw includes a heater element formed therein,
wherein said chamber further comprises a middle portion disposed between said first portion and said outlet portion, said middle portion having a barrel body including two cylindrical bores, said two cylindrical bores having either two partly overlapping cylindrical bores or two non-overlapping cylindrical bores,
wherein each cylindrical bore having one of said two feed screws rotatably disposed therein,
wherein said threads of each feed screw have a variable pitch portion that decreases as said threads approach said outlet portion of said chamber and have a linear pitch portion proximate to said first portion,
wherein said first inlet channel descends to said chamber and said second inlet channel ascends to said chamber, wherein said first and said second inlet channels attach to said chamber at a common location forming an acute angle between said first and said second inlet channels,
wherein said ceramic body is disposed within an internal cavity of a housing, said housing having:
a main body, having a first portion of said internal cavity formed therein;
at least one heater element, selected from the group consisting of an infrared heating element, a thick film heating element, a thin film heating element, a heating rod, and combinations thereof disposed within said internal cavity of said housing;
a front body having a second portion of said internal cavity formed therein;
a locking mechanism releasably securing said main body to said front body; and
a hinge mechanism, hingedly coupling said main body to said front body, wherein said ceramic body is formed as a removable ceramic insert, and said ceramic body includes a heater cavity formed in said ceramic body, said heater cavity adapted to accept a heater rod.

26. The dispensing apparatus of claim 1, wherein the chamber further comprises a middle portion disposed between said first portion and said outlet portion, said middle portion having smoothly varying tapered internal walls, said middle portion having a first diameter near said first portion and a second diameter near said second portion, wherein said first diameter is greater than said second diameter; and wherein said threads of said at least one feed screw are in sliding contact with said tapered internal walls of said middle portion of said chamber,
wherein said threads have a variable pitch portion that decreases as said threads approach said outlet portion of said chamber and have a linear pitch portion proximate to said first portion,
wherein said first inlet channel descends to said chamber and said second inlet channel ascends to said chamber, wherein said first and said second inlet channels attach to said chamber at a common location forming an acute angle between said first and said second inlet channels,
wherein said ceramic body is disposed within an internal cavity of a housing, said housing having:
a main body, having a first portion of said internal cavity formed therein;
a front body having a second portion of said internal cavity formed therein;
a locking mechanism releasably securing said main body to said front body; and
a hinge mechanism, hingedly coupling said main body to said front body,
at least one heater element, such as an infrared heating element, a thick film heating element, or a thin film heating element disposed within said internal cavity of said housing;
wherein said ceramic body is formed as a removable ceramic insert, and said ceramic body includes a heater cavity formed in said ceramic body, said heater cavity adapted to accept a heater rod.

27. A dispensing apparatus, comprising:
a ceramic body having a chamber, said chamber including an outlet portion;
means for introducing a first component viscoelastic material to said chamber;
means for introducing a second component viscoelastic material to said chamber; and
means for mixing said viscoelastic material components to form a product and simultaneously dispensing a preselected amount of said product from said outlet portion.

28. The dispensing apparatus of claim 27, wherein said means for mixing further comprises means for urging said first and said second component viscoelastic materials toward said outlet portion.

29. The dispensing apparatus of claim 27, further comprising means for heating said viscoelastic material in said chamber.

30. The dispensing apparatus of claim 27, wherein said means for mixing further comprises two feed screws each having threads, wherein each feed screw includes a heater element formed therein,
wherein said chamber further comprises a middle portion disposed between said first portion and said outlet portion, said middle portion having a barrel body including two cylindrical bores, said two cylindrical bores having either two partly overlapping cylindrical bores or two non-overlapping cylindrical bores,
wherein each cylindrical bore having one of said two feed screws rotatably disposed therein,
wherein said threads of each feed screw have a variable pitch portion that decreases as said threads approach said outlet portion of said chamber and have a linear pitch portion proximate to said first portion,
wherein said means for introducing a first component viscoelastic material descends to said chamber and said means for introducing a second component viscoelastic material ascends to said chamber, wherein said means for introducing a first component viscoelastic material and said means for introducing a second component viscoelastic material attach to said chamber at a common location forming an acute angle between said first and said second inlet channels,
wherein said ceramic body is disposed within an internal cavity of a housing, said housing having:
a main body, having a first portion of said internal cavity formed therein;
at least one heater element, selected from the group consisting of an infrared heating element, a thick film heating element, a thin film heating element, a heating rod, and combinations thereof disposed within said internal cavity of said housing;
a front body having a second portion of said internal cavity formed therein;
a locking mechanism releasably securing said main body to said front body; and
a hinge mechanism, hingedly coupling said main body to said front body, wherein said ceramic body is formed as a removable ceramic insert, and said ceramic body includes a heater cavity formed in said ceramic body, said heater cavity adapted to accept a heater rod.

31. A method of making a dispensing apparatus, comprising:
forming a ceramic body having a chamber, said chamber including a first portion and an outlet portion, said ceramic body having:
a first inlet channel delivering a first component viscoelastic fluid to said chamber, and
a second inlet channel delivering a second component viscoelastic fluid to said chamber, said first and said second inlet channels disposed to hinder interaction between said first and said second component viscoelastic fluids in either inlet channel; and
forming at least one feed screw having a thread, said at least one feed screw configured to be inserted into said chamber, wherein rotating said at least one feed screw mixes said viscoelastic fluid components to form a product and dispenses a pre-selected amount of said product from said chamber.

32. The method in accordance with claim 31, further comprising:
inserting a second feed screw into said chamber wherein said chamber further comprises a middle portion disposed between said first portion and said outlet portion, said middle portion having a barrel body including two cylindrical bores, each cylindrical bore having one of said two feed screws rotatably disposed therein.

33. The method in accordance with claim 31, further comprising forming a housing having an internal cavity, wherein said ceramic body is disposed within said internal cavity.

34. The method in accordance with claim 33, wherein forming said housing further comprises:
forming a main body, having a first portion of said internal cavity formed therein; and
forming a front body having a second portion of said internal cavity formed therein, wherein said ceramic body is formed as a removable ceramic insert.

35. The method in accordance with claim 31, further comprising forming at least one heater element disposed within said internal cavity.

36. The method in accordance with claim 31, further comprising forming at least one heater element on at least a portion of an outer surface of said chamber.

37. The method in accordance with claim 32, further comprising forming a heater element within a bore of said at least one feed screw or inserting a heater element into a bore of said at least one feed screw.

38. The method in accordance with claim 31, further comprising:
inserting a second feed screw into said chamber wherein said chamber further comprises a middle portion disposed between said first portion and said outlet portion, said middle portion having a barrel body including two cylindrical bores, each cylindrical bore having one of said two feed screws rotatably disposed therein;
forming a housing having a cavity, wherein said ceramic body is disposed within said internal cavity, wherein forming said housing further comprises:
forming a main body, having a first portion of said internal cavity formed therein;
forming a front body having a second portion of said internal cavity formed therein;
forming a locking mechanism releasably securing said main body to said front body;
forming a hinge mechanism, hingedly coupling said main body to said front body, wherein said ceramic body is formed as a removable ceramic insert; forming heater cavity in said ceramic body, said heater cavity adapted to accept a heater rod;
forming at least one heater element disposed within said internal cavity;
forming at least one heater element on at least a portion of an outer surface of said chamber; and
forming a heater element within a bore of said at least one feed screw or inserting a heater element into a bore of said at least one feed screw.

39. A method of operating a dispensing apparatus, comprising:
introducing a first component viscoelastic fluid to a chamber through a first inlet, said chamber formed in a ceramic body;
introducing a second component viscoelastic fluid to said chamber through a second inlet;
rotating at least one feed screw disposed in said chamber a pre-selected amount to:
mix said first component and said second component viscoelastic fluids,
form a viscoelastic fluid product
urge said viscoelastic fluid product to an outlet portion of said chamber, and
dispense a pre-selected quantity of said product from the dispensing apparatus.

40. The method of claim 39, wherein introducing said viscoelastic fluid further comprises:
introducing said first component viscoelastic fluid, through said first inlet, to a first feed screw disposed within said chamber; and
introducing said second component viscoelastic through said second inlet, to a second feed screw disposed within said chamber.

41. The method of claim 40, further comprising counter-rotating said first and said second feed screws a pre-selected amount.

42. The method of claim 40, further comprising co-rotating said first and said second feed screws a pre-selected amount.

43. The method of claim 39, further comprising heating said viscoelastic fluid in said chamber.

44. The method of claim 43, further comprising controlling the viscosity of said viscoelastic fluid in said chamber by controlling the temperature of said viscoelastic fluid.

45. The method of claim 43, wherein heating said viscoelastic fluid further comprises heating said viscoelastic fluid in the temperature range from about 30 degrees centigrade to about 200 degrees centigrade.

46. The method of claim 39, further comprising cleaning said chamber of said ceramic body.

47. The method of claim 46, further comprising cleaning said at least one feed screw.

48. The method of claim 46, wherein cleaning said at least one feed screw further comprises exposing either said at least one feed screw or said chamber or both to a reactive plasma treatment.

49. The method of claim 56, further comprising heating said chamber.

50. The method of claim 51, further comprising:
de-mounting said ceramic body from a mounting support; and
removing said at least one feed screw from said chamber of said ceramic body.

51. The method of claim 51, further comprising removing said ceramic body from a housing.
